(19) United States
(12) Patent Application Publication
(10) Pub. No.: US 2014/0325261 A1
(43) Pub. Date: Oct. 30, 2014

(54) METHOD AND SYSTEM OF USING A PARTITION TO OFFLOAD PIN CACHE FROM A RAID CONTROLLER DRAM

(71) Applicant: LSI CORPORATION, San Jose, CA (US)

(72) Inventors: Madan Mohan Munireddy, Bangalore (IN); Hariharan T, Bangalore (IN)

(21) Appl. No.: 13/915,580

(22) Filed: Jun. 11, 2013

(30) Foreign Application Priority Data
Apr. 26, 2013 (IN) 1885/CHE/2013

(51) Int. Cl. G06F 11/10

(52) U.S. Cl. CPC G06F 11/1092
USPC 714/6.22

(57) ABSTRACT

Disclosed is a system and method for providing data integrity for pinned cache even if a RAID controller card fails while it has pinned cache or a memory module goes bad. A controller is enabled to use complete cache lines even if pinned cache is present, thereby enabling other virtual disks to run in write-back mode when pinned cache is present.

### FIELD OF THE INVENTION

The field of the invention relates generally to cache performance with pinned cache presence in controller DRAM.

### BACKGROUND OF THE INVENTION

RAID users can generally configure a virtual disk in either write back or write through policy. Write through policy guarantees data integrity. Write back cache policy provides superior I/O throughput.

A RAID controller card may have a battery or a Supercap solution for disk failures. A battery/supercap solution can hold data (pinned cache) present in memory for a certain time period when a server does not have a power supply. When pinned cache data is present, cache lines are used to store pinned Cache and all other online virtual disks will operate in write through mode until either pinned cache is discarded or missing virtual disks are imported back to recover pinned cache through flushing.

Typically, pinned cache can be generated in at least a couple of environments. First, pinned cache may be generated when a source virtual drive with a write-back cache policy is missing during an I/O operation. This results in pinned cache generation in the controller DRAM. Second, a power failure in an enclosure/backplane/drive tray during I/O may lead to pinned cache generation in the controller DRAM.

### SUMMARY OF THE INVENTION

An embodiment of the invention may therefore comprise a method of recovering data in a RAID system, the method comprising: generating a partition in an OS disk; determining if a pin cache has been generated in a controller DRAM due to a virtual disk failure; offloading the controller DRAM pin cache contents to the generated partition on the OS disk; replacing the failed virtual disk with a new disk; and recovering the failed virtual disk by flushing the pinned cache data from the partition on the OS disk to the new disk.

An embodiment of the invention may therefore further comprise a system for recovering data in a RAID system, the system comprising: a RAID controller comprising an OS disk, wherein the OS switch is enabled to be partitioned; and at least one server connected to the OS disk; wherein: if the at least one server fails, the server is enabled to generate pin cache for its data contents in Controller DRAM; the OS disk is enabled to store pin cache data from the failed server to a partition; and the OS switch is enabled to flush the pin cache data to a new server.

### BRIEF DESCRIPTION OF THE DRAWINGS

FIG. 1 shows a server with multiple controllers configured with access to specific partitions on OS disk to store pin cache.

FIG. 2 shows a failure of two controllers in a server and offloaded cache on the partition in the OS disk.

FIG. 3 shows a recovery of offloaded cache on two controllers in a server.

FIG. 4 is a flow diagram of an algorithm to utilize a partition on an OS disk to offload pin cache from a RAID controller DRAM.

FIG. 5 is a table showing memory layout on partition in and OS disk for storing offloaded pinned cache.

### DETAILED DESCRIPTION OF THE EMBODIMENTS

Serial Attached SCSI (SAS) is a point-to-point serial protocol that is used to move data to and from computer storage devices such as hard drives and tape drives. An SAS domain is the SAS version of a SCSI domain—it consists of a set of SAS devices that communicate with one another through of a service delivery subsystem. Each SAS port in a SAS domain has a SCSI port identifier that identifies the port uniquely within the SAS domain. It is assigned by the device manufacturer, like an Ethernet device's MAC address, and is typically world-wide unique as well. SAS devices use these port identifiers to address communications to each other. In addition, every SAS device has a SCSI device name, which identifies the SAS device uniquely in the world. One doesn't often see these device names because the port identifiers tend to identify the device sufficiently.

Electrical double-layer capacitors (EDLC) are, together with pseudocapacitors, part of a type of electrochemical capacitors called supercapacitors, also known as ultracapacitors. For purposes of simplicity, the term supercapacitor or supercap will be used throughout this description to encompass the category described above. Supercapacitors do not have a conventional solid dielectric.

Typically, RAID controller cards have a battery or supercap solution to maintain data integrity if a power failure occurs. A battery or a supercap can hold data present in memory for a certain period of time when the server has its supply interrupted. This held data is termed pinned cache. The pinned cache may be maintained in the DRAM, with power being provided by the battery or supercapacitor. The pinned cache may be offloaded, using power provided by the battery or supercapacitor, to a memory area in a DFF module. It is understood that the DFF module is persistent memory. The pinned cache may be recovered upon restoration of server power. It is understood that the battery or supercap may discharge before the power supply is re-established. It is also understood that controller card which has the pinned data may itself suffer some sort of failure. A memory module may also fail resulting in memory that is not transportable. Data loss may occur.

In an embodiment of the invention, data integrity is provided for pinned cache even if a RAID Initiator, or RAID Controller, card fails while having pinned cache. Data integrity is provided likewise if the DRAM memory module goes bad in the interim. A RAID Initiator or controller card is enabled to utilize complete cache lines even if pinned cache is present. Other virtual disks are thereby enabled to run in write-back mode in the presence of pinned cache. Multiple controllers may be possibly configured in a server within a datacenter. Data integrity is provided for in the event that the faulty controller(s) is replaced. Pinned cache may be available across server reboots and power cycle of a server.

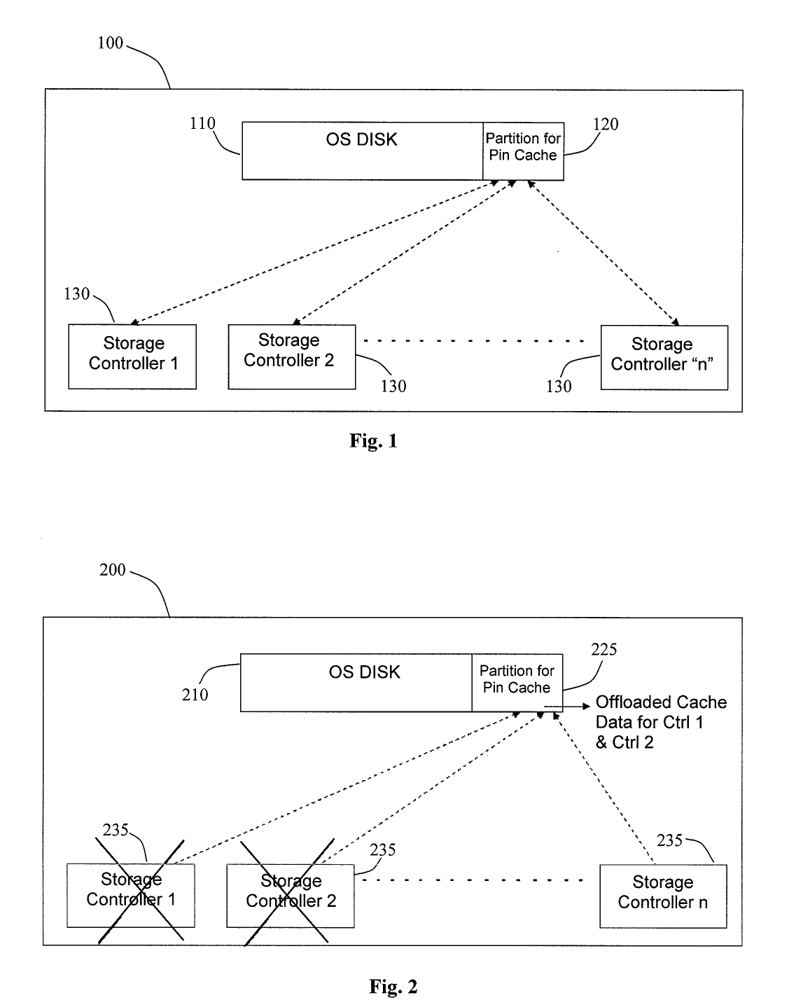

FIG. 1 shows a server with multiple controllers configured with access to specific partitions on OS disk to store pin cache. In the system 100, the OS disk 110 comprises a partition for pin cache 120. A plurality of storage controllers 130 connect to the OS disk 110. It is understood that the storage controllers 130 may be RAID controller cards, or virtual disks, with the capability to generate a pin cache in DRAM.

A user may be given an option to create and use a partition 120 on the OS disk 110. This partition may be specifically created to stored pinned cache data from the controllers 130. The partition 120 is used to store pin cache data from one or more of the controllers 130 which may be configured in the server. In the event that a controller 130 has pinned cache, firmware in the controller 130 is enabled to detect the presence of a partition 120 in the OS disk.

FIG. 2 shows a failure of two controllers in a server and offloaded cache on the partition in the OS disk. In system 200, the OS disk 210 comprises a partition for pin cache containing data for at least one of the controllers 235. As shown in FIG. 2, data from controller 1 and controller 2 has been offloaded to the partition 225 of the OS disk 210.

If the controller 235 detects a partition 220 in the OS disk 210, as noted above, the controller offloads all the pinned cache data to the partition 220 on the OS disk 210. This offloading task may be performed by firmware on the controller 235. In this manner, a copy of the data that is in the pin cache is present in the partition 220 on the OS disk 210. In the event that the controller 235 fails, or the data in the controller 235 DRAM becomes unrecoverable, or otherwise compromised, the data integrity of the pinned cache is maintained by the copy on the OS disk 210 partition 220. For instance, the data may be unrecoverable from the controller 230 DRAM due to ECC (error correcting code) errors in the DRAM or due to battery or supercapacitor failure.

It is understood that pin cache data from multiple controllers 235 may be offloaded to the partition 225. Accordingly, non-volatile RAM may be used to maintain a table detailing pin cache presence in the partition 225. The table in non-volatile memory may be updated by firmware in the controller 235. In such a manner, the pinned cache presence, from a failed disk, may be detected by other applications running on the server. The table data is accessible by such other applications unless access is denied by the system or an administrator.

Once the pinned cache data from the controllers is offloaded, the DRAMS of the controllers 235 are free of the pinned cache data. Accordingly, all cache lines will be available for use by other online write-back virtual disks for write caching and operating in the write-back mode. The DRAM may also be utilized by the Controller 235 for normal parity operations to operate on the RAID levels that involve parity calculation and parity manipulation required to perform BGOPS (BackGround Operations including but not limited to Consistency Check, Patrol Read, BackGround Initialization, Reconstruction, Copyback, etc.,) that might require cache lines.

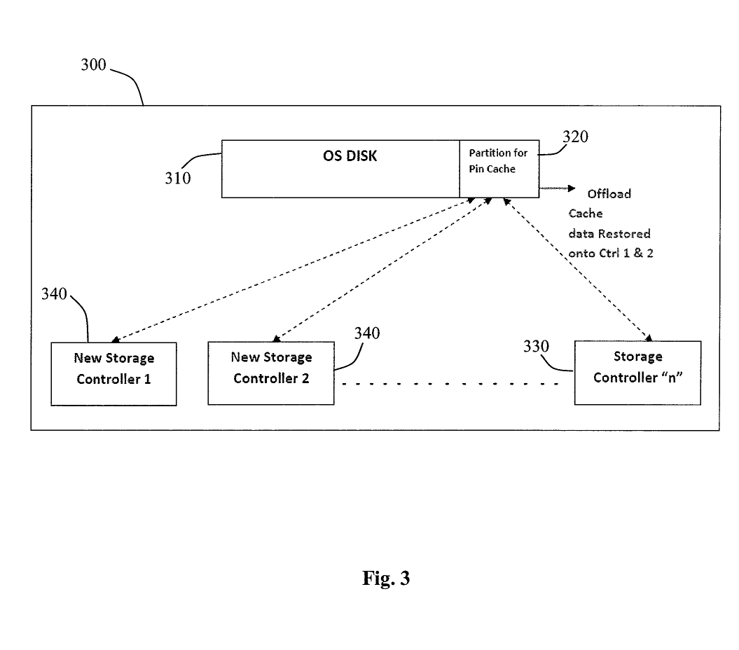

FIG. 3 shows a recovery of offloaded cache on two controllers in a server. In system 300, the OS disk 310 comprises a partition 320 for pin cache where the stored pin cache data from the failed controllers 235 of FIG. 2 is restored to new storage controllers 1 & 2 340. The controllers 330 which did not fail or continued to have recoverable data remain the same as those of FIGS. 1 and 2.

Upon recovery of the offline, or missing controllers 340, the controller 340 may check the table entries in the non-volatile RAM for the pinned cache that related to the failed controller 235. This check may be performed by firmware. The pinned cache data will be recovered from the partition 320 on the OS disk 310. This recovery will be for all new controllers 340 that are then available. The recovery may be performed by firmware. After the recovery, the firmware may clear the entries in the non-volatile RAM table for the controllers 340 that recovered pinned cache successfully from the partition 320 on the OS disk 310.

In the event that the recovery of pin cache data fails, a notification may be provided to a user or administrator indicating the failed recovery. The notification may be an AEN (Asynchronous Even Notification) from an application, for example an MSM.

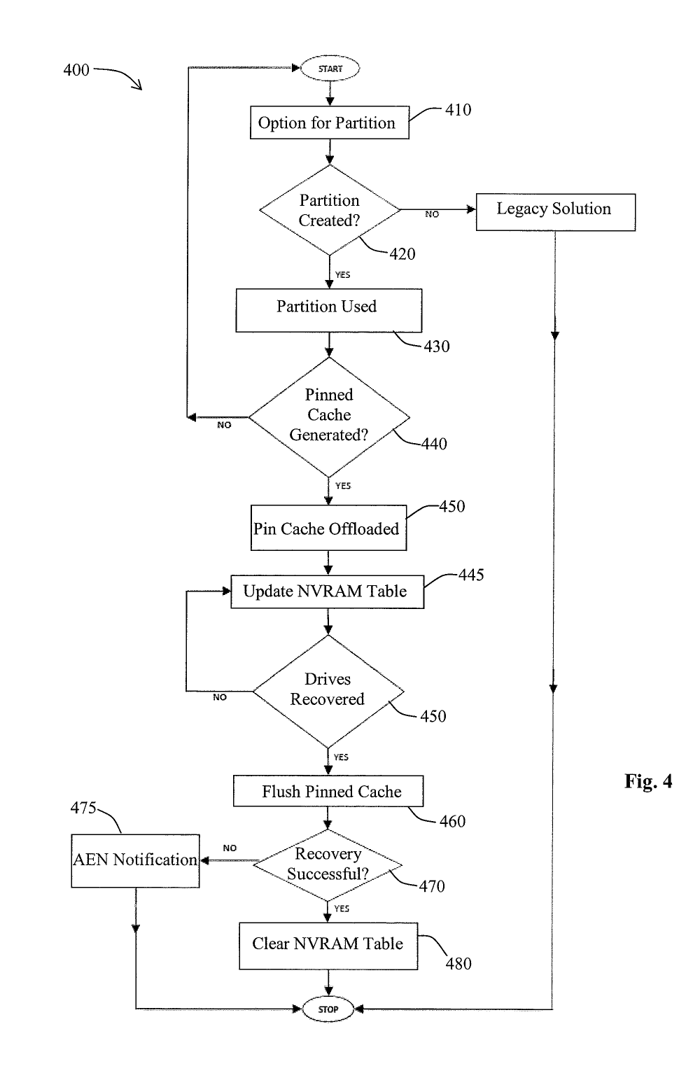

FIG. 4 is a flow diagram of an algorithm to utilize a partition on an OS disk to offload pin cache from a RAID controller DRAM. In the algorithm 400, first at step 410 a user is given an option to create a partition in the OS disk to store pin cache contents. At step 420, it is then determined whether the user has created a partition in the OS disk to store pin cache contents of the controller. If the user has not opted to create the partition, a legacy method of handling pin cache contents will be utilized. If the user has created a partition in the OS disk, at step 430 the system is enabled to utilize the partition for pinned cache from controllers. At step 440 it is determined whether at least one controller has generated any pinned cache in DRAM due to a virtual disk failure. If no pinned cache has been generated in a controller DRAM, then the algorithm will restart. If pinned cache has been generated in a controller DRAM due to a virtual disk failure, then the pin cache contents will be offloaded from the controller DRAM to the partition created on the OS disk. As noted above, it is understood that firmware may perform the offloading task. At step 445, a non-volatile RAM table may be updated to indicate the presence of pin cache in the partition of the OS disk. This table indicates the presence of pin cache for a missing virtual disk on the controller. At step 450 it is determined whether any drives of the missing virtual disk have been recovered and are available back to the controller. If no drives have been recovered, the algorithm will return to step 445. If drives have been recovered, at step 460 the pinned cache from the OS disk partition is flushed and recovered to the virtual disk. At step 470, if it is determined that the recovery was successful, then the non-volatile RAM table entry for the recovered pinned cache is cleared at step 480. Otherwise, an AEN event, at step 475, is generated to notify a user or administrator that the pinned cache recovery failed.

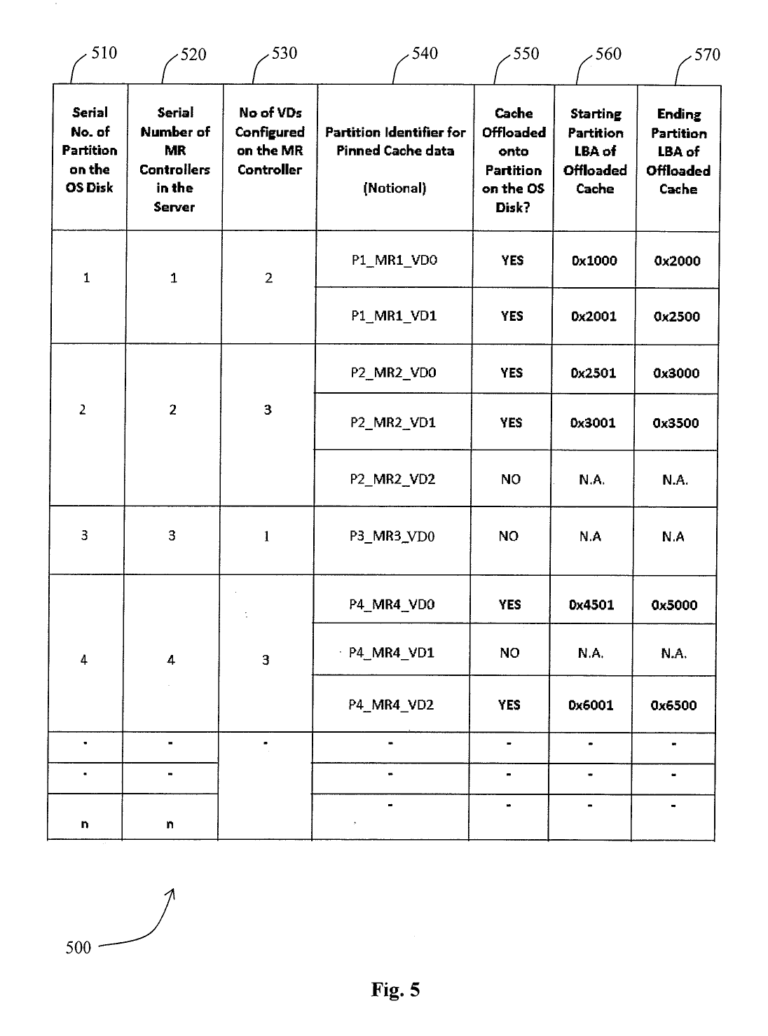

FIG. 5 is a table showing memory layout on partition in an OS disk for storing offloaded pinned cache. It is understood that different layouts of the partition may be used to accomplish pin cache offloads to the partition. The layout 500 shows a plurality of server ids 510 from 1 to n. The serial number of the RAID controller is identified with a plurality of serial number identifications 520. Within each controller, there may be a partition identifier for pinned cache data 540. The identifier 540 may indicate which RAID controller and which virtual disk is associated with the pinned cache. Another column in the table may indicate whether pinned cache data was offloaded to the partition 550. If there has been a cache offload onto partition, a starting LBA of the offloaded cache is identified 560. The end LBA of the offloaded cache is also identified 570. It is understood that a Logical block addressing (LBA) is a common scheme used for specifying the location of blocks of data stored on computer storage devices, generally secondary storage systems such as hard disks. LBA is a particularly simple linear addressing scheme. Blocks are located by an integer index, with the first block being LBA 0, the second LBA 1, and so on.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of recovering data in a RAID system, said method comprising:
generating a partition in an OS disk;
determining if a pin cache has been generated in a controller DRAM due to a virtual disk failure;
offloading said controller DRAM pin cache contents to the generated partition on said OS disk;
replacing said failed virtual disk with a new disk; and
recovering said failed virtual disk by flushing said pinned cache data from said partition on the OS disk to the new disk.

2. The method of claim 1, said method further comprising establishing a non-volatile RAM table, said table comprising information about pin cache data for the failed virtual disk.

3. The method of claim 2, wherein said information comprises cache offload to said partition status, starting LBA of offloaded cache and ending LBA of offloaded cache.

4. The method of claim 2, said method further comprising determining whether the process of recovering was successful.

5. The method of claim 4, said method further comprising clearing the table entry for said virtual disk which had a successful recovery.

6. A system for recovering data in a RAID system, said system comprising:
a RAID controller comprising an OS disk, wherein said OS switch is enabled to be partitioned; and
at least one server connected to said OS disk;
wherein:
if said at least one server fails, said server is enabled to generate pin cache for its data contents in Controller DRAM;
said OS disk is enabled to store pin cache data from said failed server to a partition; and
said OS switch is enabled to flush said pin cache data to a new server.

7. The system of claim 6, said system further comprising a non-volatile RAM table, said table comprising information about pin cache data for the failed server.

8. The system of claim 7, wherein said information comprises cache offload to said partition status, starting LBA of offloaded cache and ending LBA of offloaded cache.
